(19) United States
(12) Patent Application Publication
(10) Pub. No.: US 2003/0058559 A1
(43) Pub. Date: Mar. 27, 2003

(54) Gap fly height sensing using thermal load response

(75) Inventors: John L. Brand, Burnsville, MN (US); Toshikazu Kasai, Minnetonka, MN (US); Richard Paul Millis, St. Louis Park, MN (US); Mark Steven Jesh, Inver Grove Heights, MN (US)

Correspondence Address: MERCHANT & GOULD P.C., P.O. Box 2903, Minneapolis, MN, 55402-0903, US

(73) Assignee: Seagate Technology LLC

(21) Appl. No.: 10/087,413

(22) Filed: Mar. 1, 2002

Related U.S. Application Data
(60) Provisional application No. 60/325,842, filed on Sep. 27, 2001.

(51) Int. Cl. G11B 27/36; G11B 5/02; G11B 21/02

(52) U.S. Cl. 360/31; 360/59; 360/75

(57) ABSTRACT

A system and method for measuring the fly height of a head flying over a surface of a disc. The system includes a thermal source and a thermal detector. The system further includes a sensing device for determining the fly height of the head over the disc based on the temperature of the thermal detector. The method includes the steps of energizing the thermal source, measuring the temperature of the thermal detector, and calculating the fly height based on the measured temperature.

### RELATED APPLICATIONS

This application claims priority of U.S. provisional application Serial No. 60/325,842, filed Sep. 27, 2001.

### FIELD OF THE INVENTION

This application relates generally to fly height measurement, and more particularly to a method and apparatus for measurement of head fly height using thermal load response.

### BACKGROUND OF THE INVENTION

Storage capacity governs the amount of data a user can store on a computer. Adding storage capacity without increasing size means a more dense radial spacing of tracks on disc drives. As a result, the read/write head element's magnetic sensitivity must also increase, which makes the manufacturing process even more demanding and acceptance testing more critical.

Conventional magnetic storage devices include a magnetic transducer or “head” suspended in close proximity to a recording medium, e.g., a magnetic disc having a plurality of concentric tracks. An air bearing slider mounted to a flexible suspension supports the transducer. The suspension, in turn, is attached to a positioning actuator. During normal operation, relative motion is provided between the head and the recording medium as the actuator dynamically positions the head over a desired track. The relative movement creates a lifting force. A predetermined suspension load counterbalances the lifting force so that the slider is supported on a cushion of air. Airflow enters the leading edge of the slider and exits from the trailing end. Typically, the transducer resides toward the trailing end, which flies closer to the recording surface than the leading edge.

The recording medium holds information encoded in the form of magnetic transitions. The information capacity, or storage density, of the medium is determined by the transducer's ability to sense and write distinguishable transitions. An important factor affecting storage density is the distance between the transducer and the recording surface, referred to as the fly height. It is desirable to fly the transducer very close to the medium to enhance transition detection. Fly height stability is partially achieved with proper suspension loading and by shaping the air bearing slider surface (ABS) to obtain desirable aerodynamic characteristics.

Another important factor affecting fly height is the slider's resistance to changing conditions. An air bearing slider is subjected to a variety of changing external conditions during normal operation. Changing conditions affecting fly height include, for example, change in the relative air speed and direction, pressure changes and variations in temperature. If the transducer fly height does not stay constant during changing conditions, data transfer between the transducer and the recording medium may be adversely affected. Fly height is further affected by physical characteristics of the slider such as the shape of the air bearing surface. Careful rail shaping, for example, will provide some resistance to changes in air flow. To insure compliance with such design criteria the recording heads are typically tested in an apparatus commonly referred to as a fly height tester.

Fly height has typically been measured using optical interferometry. Optical methods require the use of glass discs that have a different roughness and waviness from product discs. Optical methods also require the gap fly height to be extrapolated from measurements of other positions on the slider. Finally, because fly heights are fractions of a wavelength, optical methods are reaching their limits of resolution.

It can be seen that there is a need for improvements in both methods and apparatus for precise measurement of head fly height.

### SUMMARY OF THE INVENTION

Against this backdrop the present invention has been developed. In one example embodiment, the invention is directed to a system for measuring head fly height in an apparatus with a rotating recording media using thermal load response. The system includes a head having a thermal source and a thermal detector. The thermal sources generate a localized heated volume or heat flux wherein the thermal loss from the head changes as a function of the fly height. The system further includes a sensing arrangement for determining the fly height of the head based on the response of the thermal detector.

In another example embodiment, the invention is directed to a system for measuring a gap in a rotating media system. The system includes a media having a first surface and a head with a second surface disposed opposite the first surface. The system further includes measuring means on the head for measuring the gap between the first and second surfaces.

Another example embodiment is directed to a method for determining fly height of a head flying over a rotating media wherein the head includes a thermal detector and a thermal source. The method includes the steps of energizing the thermal source to provide a heat flux, measuring the temperature of the thermal detector; and calculating the fly height based on the measured temperature.

These and various other features as well as advantages which characterize the present invention will be apparent from a reading of the following detailed description and a review of the associated drawings.

### BRIEF DESCRIPTION OF THE DRAWINGS

FIG. 1 is an example embodiment of a partial side view of a head and a disc used in a rotating media system.

FIG. 2 is a bottom view of the example head of FIG. 1.

FIG. 3 is an example embodiment of a head including a plurality of thermal detectors.

FIG. 4 is a flow chart illustrating an example embodiment of a method for measuring fly height using a thermal source and a thermal detector.

FIG. 5 is a chart showing inferred thermal detector temperature as a function of fly-height when 50 mA of current is applied to a thermal source with the calculated pole tip fly height as a function of fly-height included on a separate scale.

FIG. 6 is a chart illustrating measured results of a thermal detector resistance change as a function of RPM when 50 mA of current is applied to a thermal source.

### DETAILED DESCRIPTION

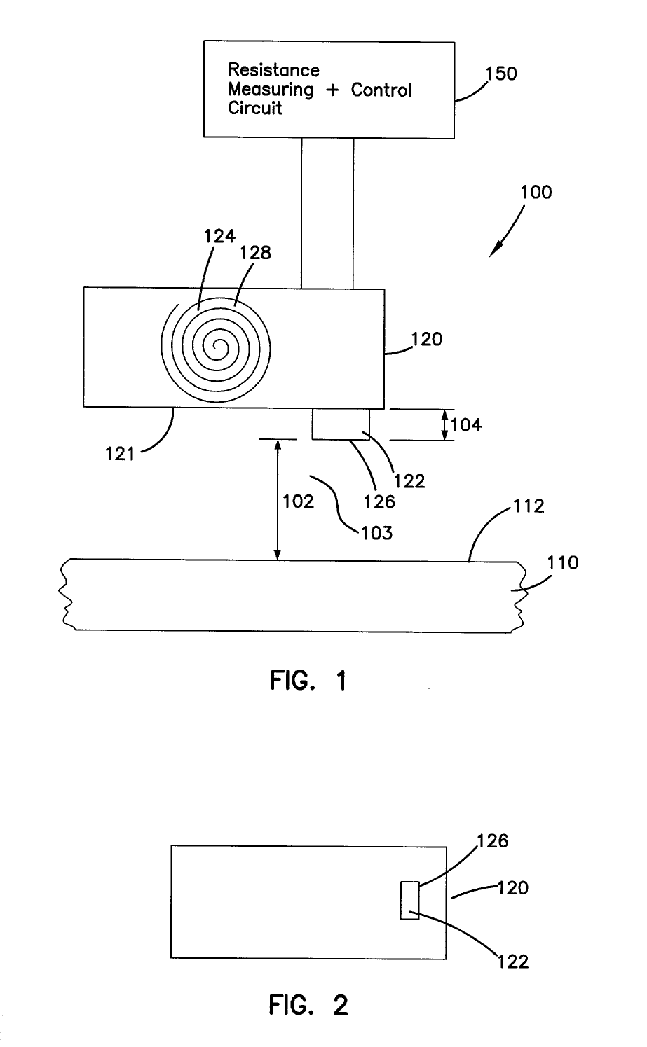

Referring to FIGS. 1 and 2, shown is an example embodiment of a measuring system 100 for determining the gap, or fly height 102, between a head 120 and a surface 112 of a recording media, such as a disc 110. Measuring system 100 can be used in a variety of systems, such as disc drives, but is useful in any system where it is desirable to know the fly height 102 of the head 120 over the media surface 112. Typically, the head 120 rests on surface 112 when the disc 110 is stationary and the head 120 flies above disc 110 when disc 110 is rotating. The height at which the head 120 flies over the surface 112 is the fly height.

Typically, head 120 includes a write element 128 and a read element 126 for writing and reading, respectively, data to and from disc 110. Elements on the head 120 are in electrical communication with circuitry (not shown) that sends and receives data and other signals and, generally, the circuitry (not shown) controls operation of the disc drive. The head 120 has a face 121 that is located proximately to the surface 112 of the disc 110. Typically, the read element 126 protrudes from the head 120 toward the surface 112 of the disc 110. The distance that the read element 126 protrudes from the face 121 of the head 120 is called the pole tip recession 104 (PTR). Generally, the operation most sensitive to the head 120 fly height 102 is reading the data on the disc 110, and it is most critical to know the fly height from the read element 126 to the surface 112 of the disc 110.

Measuring system 100 for determining fly height 102 includes a thermal source 124 and a thermal detector 122. In the example embodiment shown, write element 128 functions as the thermal source 124 when sufficient current is passed though the write element 128. The amount of heat generated by the thermal source 124 is a function of the electrical resistance of the write element 128 and the current being passed through write element 128. The read element 126 functions as the thermal detector 122. Preferably temperature is measured as a function of electrical resistance of the read element 126. The present invention determines fly height 102 by measuring the temperature of the thermal detector 122, which has been found to vary with fly height 102 as will be discussed in more detail hereinafter.

While in the example embodiment shown the thermal source 124 is the write element 128 and the thermal detector 122 is the read element 126, a separate element for the thermal source 124 other than the write element 128 can be used. Similarly, a separate element for the thermal detector 122 other than the read element 126 can be used, depending on the configuration desired and the amount of space available on the head 120. For example, the thermal detector 122 could be a separate resistive temperature device (RTD). The sensitivity (change in resistance/change in temperature) of the RTD could be selected so that the output is in a linear range given a set of operating conditions in which the measuring system 100 would be used. Over wider ranges, the output of the RTD could be linearized. One of skill in the art will recognize that a separate thermal sensing arrangement 150 including a resistance measuring and control circuit can be added to circuitry already coupled to the read and write elements 126, 128, respectively, to determine the temperature of the thermal detector 122, and consequently, the fly height 102. The thermal sensing arrangement 150 includes a device to measure the temperature output variable, preferably resistance. The thermal sensing device 150 can also include a device to convert the measured temperature directly into a fly height 102 measurement.

An advantage of using a separate device as the thermal source 124 instead of the write element 128 is that the thermal source can be more localized to the gap 103, and thermal detector 122 is more sensitive to the gap 103 spacing than by using the write element 128 as a thermal source 124. A separate thermal source 124 also has the advantage that it is less likely to rewrite the disc 110 by imparting sufficient energy to the write element 128 to write data to the disc 110.

One of skill in the art will recognize that the type and sensitivity of the thermal source 124 and thermal detector 122 can be selected from a wide variety of commonly available items, and selection depends on the particular configuration in which the measuring system 100 is to be used. It is preferable to use a thermal detector 122 that has a change in resistance as a function of changing temperature since the resistance can be measured using components generally present in the type of systems in which the present invention is useful. Resistance can be measured in a number of ways. For example, the resistance can be measured using constant current and measuring the change in voltage.

Resistance can also be measured using constant voltage and measuring the change in current. Additionally, resistance can also be measured using constant power and measuring the change in both voltage and current or using a four-point probe method, which uses separate pairs of leads for the current source and voltage measurement. In the example embodiment shown, the current used to energize the thermal source 124 is between 10 and 30 milliamps, though the particular range depends on the type and location of the thermal source 124 used.

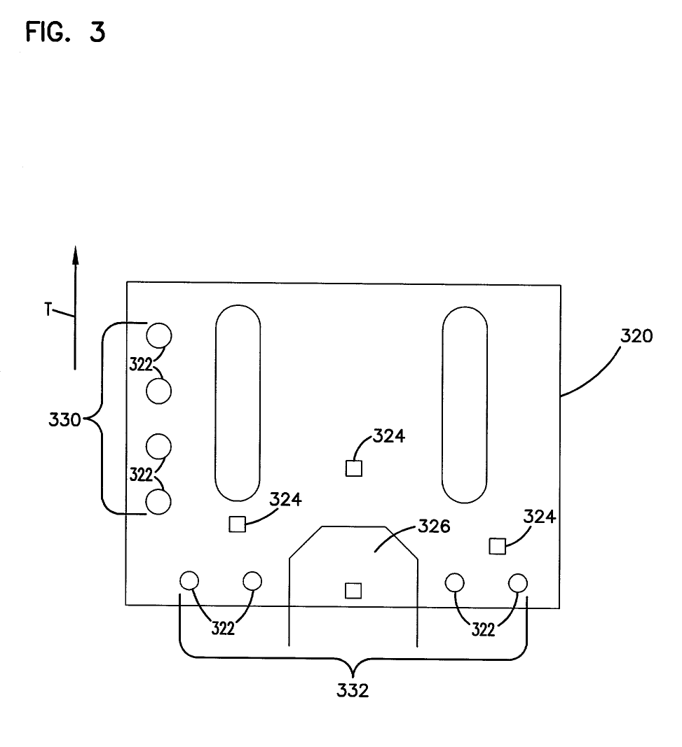

Referring to FIG. 3, shown is an example embodiment of a head 320 including multiple thermal detectors 322. While one thermal detector 322 is generally sufficient to measure the fly height of the head 320 or the read element, placing multiple thermal detectors 322 on the head 320 allows other parameters to be measured. For example, pitch and roll attitude could all be measured using properly positioned thermal detectors 322. In the example embodiment shown, pitch can be measured by determining the localized fly height of the head 320 containing each thermal detector 322. In a first row 330 oriented along the head 320 in the direction of relative motion between the head 320 and the disc as shown by arrow T, each thermal detector 322 will be at a different height depending on the pitch of the head 320. The pitch can be determined by knowing the angle formed due to each sensor being at a different height over the surface of the disc. Roll of the head 320 can be determined in a similar fashion using the row of thermal detectors 322 running in a second row 332 perpendicular to the direction arrow T of relative motion between the head 320 and the rotating disc.

One of skill in the art will recognize that as many parameters can be measured by using a number of thermal detectors 322 at least equal to the number of parameters that are desired to be determined. Since the relative location of each thermal detector 322 on a head 320 will be known (as part of the design and manufacturing criteria for each head 320), a system of equations approximating each of the measured parameters can be solved simultaneously to yield the desired results. Additionally, a thermal sensing circuit can be formed that incorporates the thermal source and thermal detector 322 into a single apparatus.

The use of the measuring system 100 described above depends on using a parameter that varies with a change in temperature, such as resistance. For example, in using resistance of a thermal detector 322 to determine temperature, the resistance of most conductors increases with temperature. Over small temperature ranges, the sensitivity varies linearly with temperature. The resistance typically increases with temperature for materials used for both the read and write elements.

The measurement system of the present invention utilizes principles of heat or thermal transfer. Thermal transfer is typically characterized as one or a combination of conduction, convection, and black body radiation.

Referring to FIG. 2, in the case of loss through the gap 103 between the head 120 and the surface 112 of the disc 110, an additional quantum mechanical loss mechanism is also present since the gap height is typically less than the thermal wave length of radiated heat. To a first order approximation, the thermal transfer from the flying read element 126 to the disc 110 due to this close proximity will fall off as a function of the exponential power of the fly height 102.

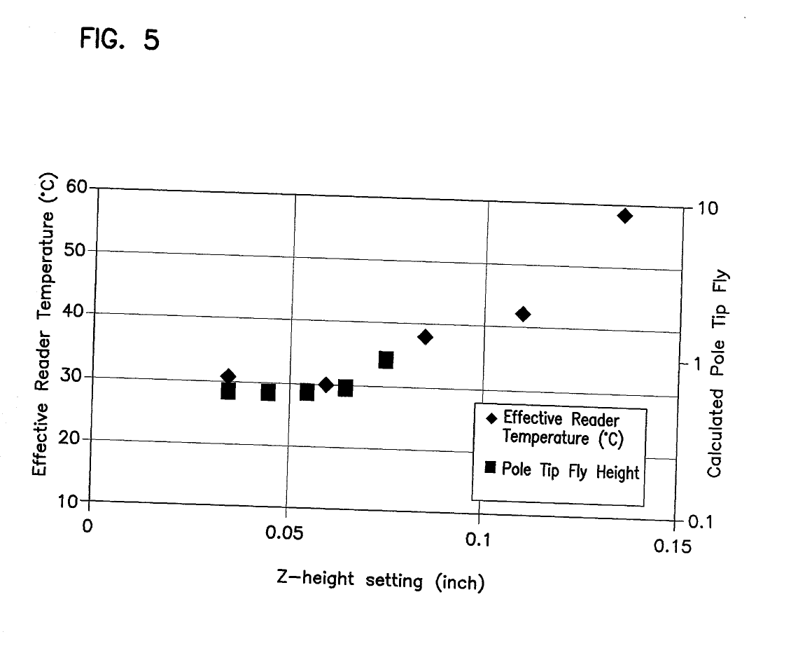

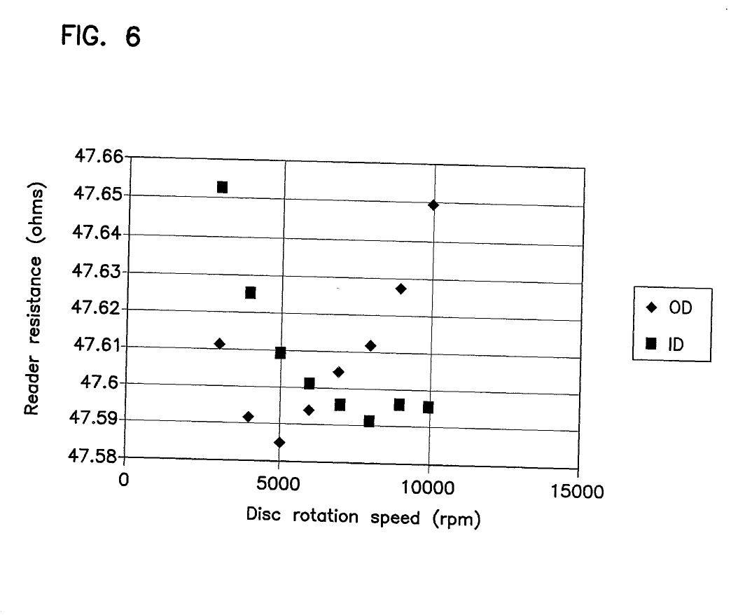

Referring to FIGS. 5 and 6, these combined effects are demonstrated. FIG. 5 shows the calculated gap fly height 102 plotted on a log scale to show the exponential relationship. In the normal convective heat transfer regime, the thermal transfer is generally proportional to the relative velocity between the disc 110 and the head 120. As shown in FIG. 5, for the thermal loss due to smaller spacings, this is not the case. FIG. 6 shows the read element 126 resistance as a function of the velocity of the disc 110 measured in revolutions per minute or RPM. If the convective losses dominated, then the read element 126 resistance should decrease continuously with RPM at both radii at which it was measured. In addition, the outer diameter resistance should be lower at each RPM because the linear velocity is about twice the inner diameter linear velocity.

A method to measure indirectly the fly height 102 by measuring the change in temperature of a thermal detector 122 when a thermal source provides a heat source is also disclosed. As can be seen in FIGS. 5 and 6, the thermal transfer between the head 120 and the disc 110 is a sensitive function of fly height 102.

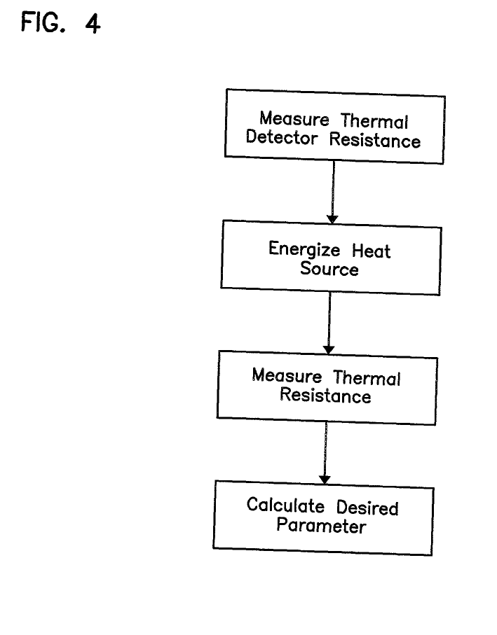

Referring to FIG. 4, shown is a flowchart of an example embodiment of a method of determining fly height. When using a thermal detector that uses resistance change to measure temperature, the resistance is read and the temperature of the thermal detector is determined. The thermal source is turned on or energized to provide a heat flux. The thermal source measures the temperature, typically by measuring resistance. The step of measuring the thermal detector response can also include providing sub-writing currents to the writer.

By energizing the thermal source and measuring the temperature of the thermal detector, the fly height can be determined. A look-up table based on empirical data, such as that shown in FIGS. 5 and 6, can be used to determine fly height. Circuitry can also be used to accomplish the same result. It is well within the knowledge of one of skill in the art to design circuitry to determine fly height based on a particular arrangement of thermal detectors on the head and the parameters that are desired to be measured. In addition to energizing the thermal source in a static manner, the thermal source can be cycled in a variety of waveforms. The phase delay and amplitude of the thermal detector signal will be sensitively dependent on the geometry of the devices and the gap spacing. In addition to varying the thermal source, the thermal detector can be energized with a variety of waveforms in order to optimize the response with respect to the thermal source.

While the measuring system has been described in reference to a disc drive system, it is useful in any system where it is desirable to measure fly height, such as optical recording (CD, DVD, and other systems). Additionally, mechanical systems, such as spindle motors, brakes, and precision tooling, with close tolerances (on the scale of less than 100 nm) could also incorporate the measuring system.

It will be clear that the present invention is well adapted to attain the ends and advantages mentioned as well as those inherent therein. While presently preferred embodiments have been described for purposes of this disclosure, various changes and modifications may be made which are well within the scope of the present invention. Numerous other changes may be made which will readily suggest themselves to those skilled in the art and which are encompassed in the spirit of the invention disclosed and as defined in the appended claims.

What is claimed is:

1. A system for measuring head fly height in an apparatus with a rotating recording media using thermal load response, comprising:
a head having a thermal source and a thermal detector, wherein the heat source generates a heat flux that is measured at the thermal detector when the media is rotating; and
a sensing arrangement for determining the fly height of the head based on the temperature of the thermal detector.

2. The system of claim 1 wherein the thermal source is a write element.

3. The system of claim 1 wherein the thermal detector is a read element.

4. The system of claim 1 wherein the sensing arrangement includes a constant voltage element for determining the temperature of the thermal detector.

5. The system of claim 1 wherein the sensing arrangement includes a constant current element for determining the temperature of the thermal detector.

6. The system of claim 1 further including a plurality of thermal detectors located on the head.

7. The system of claim 6 wherein each thermal detector has its respective temperature sensed with a dedicated thermal sensor.

8. A method for determining fly height of a head flying over a rotating media, the head including a thermal detector and a thermal source, the method comprising the steps of:
energizing the thermal source to provide a heat flux;
measuring the temperature of the thermal detector; and
calculating the fly height based on the measured temperature.

9. The method of claim 8 wherein said step of energizing the thermal source includes energizing the write element.

10. The method of claim 8 wherein said step of energizing the thermal source includes inducing a transient thermal response in the thermal source.

11. The method of claim 8, wherein the step of measuring further includes measuring the temperature of multiple thermal detectors positioned on the head.

12. The method of claim 8 wherein the step of calculating the fly height includes determining fly height using a look-up table of values.

13. The method of claim 8 where said step of measuring further includes measuring the response of the thermal detector over data while sub-writing currents flow to the writer.

14. A system for measuring a gap in a rotating system, the system comprising:
a first object having a first surface and a second object having a second surface disposed opposite the first surface; and
means for measuring the gap between the first and second surfaces.

15. The system of claim 14 wherein the means includes means for measuring pitch of the first object relative to the second object.

16. The system of claim 14 wherein the second object is a compact disc or a digital versatile disc and the first object is a read head.

17. The system of claim 14 wherein the means includes a thermal source and a thermal detector.

18. The system of claim 14 wherein the means includes a plurality of thermal detectors on the second object.

19. The system of claim 18 wherein each thermal detector has a dedicated thermal source.

20. The system of claim 18 wherein the plurality of thermal detectors is arranged in a row parallel to the direction of travel of the first object relative to the second object.
